(19) United States
(12) Patent Application Publication
(10) Pub. No.: US 2025/0201047 A1
(43) Pub. Date: Jun. 19, 2025

(54) METHOD FOR PRODUCING VALUE DOCUMENTS, AND SENSOR SYSTEM FOR QUALITY CONTROL DURING THE PRODUCTION OF VALUE DOCUMENTS

(71) Applicant: GIESECKE+DEVRIENT CURRENCY TECHNOLOGY GMBH, Munchen (DE)

(72) Inventors: Thomas GIERING, Kirchseeon (DE); Thomas HAPP, Munchen (DE)

(21) Appl. No.: 18/845,715

(22) PCT Filed: Feb. 7, 2023
(86) PCT No.: PCT/DE2023/100095

§ 371 Date: Sep. 10, 2024

(30) Foreign Application Priority Data
Mar. 17, 2022 (DE) 10 2022 000 932.3

(51) Int. Cl. B42D 25/41; G07D 7/1205

(52) U.S. Cl. CPC G07D 7/1205

(57) ABSTRACT

A method for producing value documents and a sensor system for quality control during the production of value documents, wherein a first optical radiation emanating from a first semi-finished product is captured with a first sensitivity and a first resolution and is tested on the basis of a first test criterion. If the first test criterion is satisfied, the following steps are carried out: introducing and/or applying at least one feature substance into and/or onto the first semifinished product, wherein a value document or a second semifinished product is obtained; capturing a second optical radiation emanating from the value document or the second semifinished product with at least one second sensitivity and at least one second resolution; and testing the second optical radiation on the basis of at least one second test criterion.

The invention relates to a method for producing value documents, in particular banknotes, and to a sensor system for quality control during the production of value documents.

In order to safeguard value documents and check their authenticity or classify them, it is known for machine-testable security features to be introduced into and/or applied onto the value documents. In the case of an optical check of authenticity or classification, the value document is irradiated with light by a sensor, and the light emitted, reflected or transmitted by the value document is detected and analyzed in order to check the feature or to assign the value document to a class.

During the production of such value documents, quality control is generally provided in order to ensure that the finished value documents contain the feature in a predetermined quantity and/or with predetermined properties. For this purpose, provision can be made for testing the value documents at least in the manner of random sampling and for releasing them as circulatable only if they satisfy these predefined criteria, whereas all the other value documents are segregated as rejects and, if appropriate, destroyed. For the purposes of comprehensive protection against forgery, the properties tested on the finished value document or the reference values of said properties should as far as possible be prevented from being made accessible to a large group of people.

It is an object of the invention to specify a method for producing value documents and a sensor system for quality control during the production of value documents in and respectively by which, in a simple manner, efficient production and dependable quality control of value documents are made possible and, in particular, the material rejects are reduced.

This object is achieved by a method for producing value documents and a sensor system for quality control during the production of value documents as claimed in the independent claims.

In accordance with a first aspect of the present disclosure, a method for producing value documents, in particular banknotes, comprises the following steps: providing at least one first semifinished product; capturing a first optical radiation emanating from the first semifinished product with at least one first sensitivity and at least one first resolution of temporal, spatial and/or spectral properties of the first optical radiation, and testing the first optical radiation on the basis of a first test criterion and, if the first test criterion is satisfied, introducing and/or applying at least one feature substance into and/or onto the first semifinished product, wherein a value document or a second semifinished product usable for producing a value document is obtained; capturing a second optical radiation emanating from the value document or the second semifinished product with at least one second sensitivity and at least one second resolution of temporal, spatial and/or spectral properties of the second optical radiation, and testing the second optical radiation on the basis of at least one second test criterion and, if the at least one second test criterion is satisfied, releasing the value document for circulation or releasing of the second semifinished product for use in the production of a value document. In this case, the first sensitivity is greater than the second sensitivity and/or the first resolution is less than the second resolution and/or the testing of the first optical radiation with regard to the temporal, spatial and/or spectral properties of the first optical radiation is less selective than the testing of the second optical radiation with regard to the temporal, spatial and/or spectral properties of the second optical radiation.

A second aspect of the present disclosure relates to a sensor system for quality control during the production of value documents which involves at least one feature substance being introduced into and/or applied onto a first semifinished product in order to obtain a value document or a second semifinished product usable for producing a value document. The sensor system comprises at least one capture apparatus for capturing optical radiation and at least one test apparatus for testing the captured optical radiation and is operable in a first operating mode and in a second operating mode. In the first operating mode, which in connection with the present disclosure is also referred to as “clean mode”, a first optical radiation emanating from the first semifinished product is captured by the at least one capture apparatus with at least one first sensitivity and at least one first resolution of temporal, spatial and/or spectral properties of the first optical radiation, and is tested by the at least one test apparatus on the basis of a first test criterion, wherein a first test signal is generated and/or output, which is dependent on whether the first test criterion is satisfied. In the second operating mode, which in connection with the present disclosure is also referred to as “measurement mode”, a second optical radiation emanating from the value document or from the second semifinished product is captured by the at least one capture apparatus with at least one second sensitivity and at least one second resolution of temporal, spatial and/or spectral properties of the second optical radiation, and is tested by the at least one test apparatus on the basis of at least one second test criterion, wherein a second test signal is generated and/or output, which is dependent on whether the at least one second test criterion is satisfied. In this case, the first sensitivity is greater than the second sensitivity and/or the first resolution is less than the second resolution and/or the testing of the first optical radiation with regard to the temporal, spatial and/or spectral properties of the first optical radiation is less selective than the testing of the second optical radiation with regard to the temporal, spatial and/or spectral properties of the second optical radiation.

Aspects of the present disclosure are preferably based on the approach in which, during the production of a value document, at least one first semifinished product, in particular a representative random sample of a first semifinished product, before the introduction and/or application of the feature substance, which in connection with the present disclosure is also referred to as “feature” or “security feature”, into and/or onto the first semifinished product, is tested using a sensor in order to ensure that the first semifinished product contains no contaminants that disturb the measurement of feature properties, or contains contaminants only in an amount such that they do not disturb, or do not significantly disturb, the measurement of the feature properties on the end product, in particular on a value document or second semifinished product produced using the first semifinished product. In this case, a first optical radiation emanating from the first semi-finished product, which radiation in connection with the present disclosure is also referred to as “signal intensity”, is captured with a high sensitivity and/or with a low spatial, temporal and/or spectral resolution and/or is tested with a low spatial, temporal and/or spectral resolution and/or selectivity. The resolution during capture and/or the resolution and/or the selectivity during testing are/is also referred to as “specificity” in connection with the present disclosure. The first semifinished product is released for further processing to form a value document or a second semifinished product usable for producing a value document only if the measured signal intensity satisfies a first test criterion, for example by virtue of its lying below a first threshold value. In a further example, the first test criterion can be satisfied if a difference between two measured signal intensities of the first optical radiation, for example signal intensities at different detection wavelengths, lies below a first predefined threshold value. By way of example, this can be a measure of the contrast of a signal peak above a background. Optionally, a signal intensity, in particular its maximum over a predetermined measurement time period and/or spatial measurement range, can be output by the sensor and, in particular, displayed for an operator. Alternatively or additionally, provision can be made for outputting corresponding information concerning the result of the test (e.g. “OK” or “NOT OK”) to the operator.

After optional further intermediate steps, the feature substance is subsequently introduced into and/or applied onto the first semifinished product released for further processing, whereby a feature-containing second semifinished product or a feature-containing value document is obtained or produced.

A second optical radiation emanating from the second semifinished product or value document obtained or produced in this way, which radiation in connection with the present disclosure is also referred to as “feature intensity”, in particular on a representative random sample, is captured with a higher spatial, temporal and/or spectral resolution and/or a lower sensitivity and/or is tested with a higher spatial, temporal and/or spectral resolution and/or selectivity than the first optical radiation. The resolution during capture and/or the resolution and/or the selectivity during testing are/is also referred to as “specificity” in connection with the present disclosure. Preferably, the feature intensity is measured or tested with higher specificity than the signal intensity.

The captured second optical radiation is tested on the basis of at least one second test criterion. If the at least one second test criterion is satisfied, the second semifinished product is released for further processing or the value document is released as circulatable.

In this case, the first measurement on the non-feature-containing first semifinished product has a higher sensitivity and/or a lower specificity than the second measurement on the feature-containing second semifinished product or value document. Higher sensitivity preferably means that a lower intensity already leads to a detector signal that is distinguishable from noise. Lower specificity preferably means that the first measurement on the first semifinished product, with regard to the temporal and/or spatial and/or spectral properties of the first optical radiation emanating from the first semifinished product, is less selective than the second measurement on the second semifinished product or value document.

By way of example, the temporal measurement range and/or the spatial measurement range and/or the spectral measurement range of the first measurement are/is greater than the corresponding measurement range of the second measurement. In the case of the first measurement, e.g. temporal and/or spatial and/or spectral integration can be effected, while in the case of the second measurement, in the corresponding measurement range (e.g. that of the first measurement), a plurality of temporally/spatially/spectrally different measurement points are captured. In this case, preferably, the temporal measurement range of the second measurement is contained in that of the first measurement and/or the spectral measurement range of the second measurement is contained in that of the first measurement.

Alternatively or additionally, in the case of the first measurement, the data are taken into account without selection or with less selection than in the case of the second measurement; by way of example, no restriction with regard to the decay times and/or no restriction with regard to the distribution of the feature signals and/or no restriction with regard to the spectral shape of the signals occur(s) in the case of the first measurement.

Preferably, an irradiation of the first semifinished product during the first measurement encompasses all spectral components which are also used for irradiating the second semifinished product or the value document during the second measurement.

Particularly preferably, the parameters for irradiation used during the first measurement are the same (with regard to spectrum, modulation and/or intensity) as those used during the second measurement.

However, the irradiation of the first semifinished product during the first measurement can also be over a spectrally wider band and/or modulated temporally to a lesser extent than the irradiation during the second measurement. By way of example, the irradiation can be pulsed during the second measurement and continuous during the first measurement. By way of example, two wavelengths are alternately radiated onto the value document or the second semifinished product during the irradiation during the second measurement, while both wavelengths are simultaneously radiated onto the first semifinished product during the first measurement.

In this way, during the second measurement of the feature intensity at the value document or the second semifinished product, the characteristic property of the feature substance contained therein can be accurately tested, while the preceding first measurement of the signal intensity at the first semifinished product is fast and simple and in particular also more sensitive with regard to small contaminants and reveals no and/or only few details concerning characteristic properties of the feature substance and/or test criteria and/or reference values in this respect, or these are not even tested in the first place.

As a result, contaminants in the first semifinished product which may disturb the feature measurement on the second semifinished product or the value document can be identified at an early stage and, if appropriate, avoided by segregation of the relevant semifinished product. This avoids or at least greatly reduces the risk that even if the feature substance has been correctly introduced and/or applied and metered, a sufficient correspondence between the property (properties) ascertained from the captured second optical radiation and a predetermined reference cannot be established, and so the actually finished second semifinished product or actually finished value document would have to be discarded or destroyed, which constitutes a considerable outlay. The testing of the first semifinished product and respectively the first operating mode of the sensor system thus overall reduce the material rejects and enable faster and more efficient production of value documents.

Furthermore, it is possible to carry out the quality control measurements necessary in such a production method during the production of the value document, in particular on the first semifinished product, using a sensor or sensor system that is the same as or at least structurally identical to that for the final inspection of the finished value document. This enables a reduced requirement in respect of material and space (one sensor vs. two sensors) and a better comparability of the measurements. By way of example, a sensor used for capturing and testing the second optical radiation is the same as or structurally identical to (with respect to its hardware or measuring elements) that used for capturing and testing the first optical radiation. The structurally identical sensors may differ, however, in their software.

In summary, it should be stated that the method and the sensor system in accordance with the present disclosure make possible, in a simple manner, efficient production and dependable quality control of value documents, in which case, in particular, material rejects are reduced.

Within the meaning of the present disclosure, the term “capture” preferably encompasses both irradiation of the first and/or second semifinished product or the value document in order to cause same to emit the first and/or second optical radiation, and detection of the optical radiation emanating from the first and/or second semifinished product or the value document in response to the irradiation.

Accordingly, during capture, a higher or lower sensitivity and/or resolution can be attained by way of a corresponding configuration and/or manner of operation of a detector device (e.g. integration times, number and/or position of spectral channels, sampling rates, etc.) and/or by way of a corresponding configuration and/or manner of operation of an irradiation device (e.g. intensity, spectral composition, temporal modulation, etc.).

By way of example, it is possible to attain a higher sensitivity when capturing the first optical radiation in the first operating mode by virtue of the fact that the intensity of the optical radiation with which the first semifinished product is irradiated is greater than when irradiating the second semifinished product or the value document in the second operating mode. Alternatively or additionally, however, provision can also be made for setting longer integration or averaging times at the detector device when detecting the first optical radiation in the first operating mode compared with when capturing the second optical radiation in the second operating mode.

By way of example, it is possible to attain a lower spectral resolution during capture or a lower spectral selectivity during testing of the first optical radiation in the first operating mode by virtue of the fact that the detector device comprises only one spectral channel, which can capture the first optical radiation in a wideband fashion, or comprises a plurality of spectral channels, which however are considered together or as a totality, for example by the intensities detected in all the spectral channels being summed and/or averaged and/or a maximum value being determined therefrom in order to obtain a signal intensity, whereas in the second operating mode only the intensities captured in one (narrowband) spectral channel of the detector device or in a plurality of spectral channels of the detector device are taken into account in the testing.

By way of example, it is possible to attain a lower spatial resolution during capture or a lower spatial selectivity during testing of the first optical radiation in the first operating mode by virtue of the fact that the detector device captures the first optical radiation emanating from the first semifinished product over a wide spatial range or—in the case of capture along a plurality of measurement tracks during a relative movement—from a plurality of tracks, which radiation is considered together or as a totality, for example by the intensities detected in the individual tracks being summed and/or averaged and/or a maximum value being determined therefrom in order to obtain a signal intensity, whereas in the second operating mode only the intensities captured in one or a plurality of (determined) tracks are taken into account separately in the testing.

Further examples for realizing a lower specificity when capturing and/or testing the first optical radiation in comparison with capturing and/or testing the second optical radiation are described further below in association with the figures.

Preferably, on the basis of the first test criterion, a test is conducted to check whether an intensity of the first optical radiation is less than a predefined first threshold value. This makes it possible, in a simple and reliable manner, to ensure that the first semifinished product is released for further processing to form the second semifinished product or the value document only if the first semifinished product contains no contaminants or contains contaminants only in an amount such that the optical radiation attributed to the contaminants does not disturb, or at least does not significantly impair, a measurement or determination of properties of the feature substance contained in the second semifinished product or the value document.

Preferably, on the basis of the second optical radiation, at least one characteristic property of the feature substance introduced into and/or applied onto the value document or the second semifinished product is ascertained and, in a first test step on the basis of the at least one second test criterion, a test is conducted to check whether the ascertained characteristic property of the feature substance corresponds or is at least similar to at least one predefined property. This makes it possible to reliably deduce the presence of a specific or desired feature substance in the second semifinished product or the value document (qualitative testing of the feature substance).

The at least one characteristic property of the feature substance or the predefined property is preferably at least one of the following properties of the second optical radiation emanating from the feature substance and/or the second semifinished product or the value document: i) spectral properties, such as e.g. the intensity in specific spectral ranges (fingerprint), the position, intensity or width of spectral maxima, minima or shoulders, in absolute terms or relative to one another; ii) temporal properties, such as e.g. the intensity at specific points in time relative to an excitation pulse of the irradiation, in absolute terms or relative to one another, a decay or build-up time, a profile or a functional shape (fit parameter) of the temporally resolved feature intensity, the position or intensity of a temporal intensity maximum; iii) combinations of spectral and temporal properties (e.g. decay times in a plurality of spectral channels, emission spectrum at a plurality of measurement instants); iv) properties after complex excitation by the irradiation (e.g. a plurality of excitation wavelengths, complex temporal modulation of the excitation light).

Preferably, in a second test step on the basis of the at least one second test criterion, a test is conducted to check whether an intensity of the second optical radiation is greater than a predefined second threshold value and/or lies within a predefined tolerance interval. This makes it possible, in a simple manner, to deduce the presence of a specific or desired quantity of a/the desired feature substance in the second semifinished product or the value document (quantitative testing of the feature substance).

Preferably, the second test step is carried out after the first test step and/or the second test step is carried out only if the at least one second test criterion is satisfied in the first test step. In the latter alternative, therefore, in the first step, a test is conducted to check whether the characteristic property is sufficiently close to a reference predetermined for the respective value document class, i.e. whether the feature substance or the second optical radiation emanating from the feature substance has the properties predetermined for the value document class. It is only if this test is successful that, in the second step, a test is conducted to check whether the feature intensity lies above a second threshold value or within a predefined tolerance interval, i.e. whether the feature substance was metered correctly. It is only if this test, too, is successful that the second semifinished product is released for further processing or the value document is released as circulatable. By this means, therefore, the feature substance is tested from both a qualitative and a quantitative standpoint, such that the presence of a specific quantity of a specific feature substance in the second semifinished product or the value document can be deduced.

The feature substance in the value document or in the second semifinished product is invisible to the naked eye under ambient light. Preferably, a feature substance is used wherein the light wavelengths used or usable during the testing for an irradiation and/or the emanation (reflection, transmission, emission) of optical radiation lie in the invisible spectral range. This increases the forgery-proofness or hampers detectability for unauthorized groups of people.

Within the meaning of the present disclosure, the term “optical radiation” can be understood as electromagnetic radiation in the infrared and/or visible and/or ultraviolet spectral range, preferably between 100 nm and 100 μm, particularly preferably between 200 nm and 3000 nm. In this range, radiation sources and detectors can be operated at room temperature and under ordinary air.

The invisible spectral range can comprise the infrared and ultraviolet spectral range, preferably between 100 nm and 380 nm and between 780 nm and 100 μm.

Preferably, the captured first and/or second optical radiation are/is characteristic of at least one of the following optical properties of the first semifinished product and/or the value document or the second semifinished product: luminescence (fluorescence, phosphorescence), Raman scattering, in particular surface-enhanced Raman scattering (SERS), and/or absorption. Preferably, the at least one feature substance has characteristic properties with regard to luminescence, Raman scattering and/or absorption which reliably, preferably unambiguously, distinguish it from other feature substances. This enables high forgery-proofness and hampered detectability by unauthorized groups of people.

Preferably, the captured first and second optical radiation are characteristic of the same optical property of the first semifinished product and the value document or the second semifinished product. Preferably, capturing the first optical radiation at the first semifinished product (first operating mode) and capturing the second optical radiation at the second semifinished product or the value document (second operating mode) are effected by the same optical measurement method, in particular both by measurement of the luminescence (by capture of the emitted optical radiation), or both by measurement of the Raman scattering, in particular surface-enhanced Raman scattering (SERS) (by Raman spectroscopy), or both by measurement of the absorption (by measurement of reflection and/or transmission). The quality control measurements performed on the first semifinished product during the production process can thereby be carried out using a sensor or sensor system that is the same as or at least structurally identical to that for the final inspection of the finished value document, whereby the requirement in respect of material and space (one sensor vs. two sensors) is reduced and/or a better comparability of the measurements is attained.

Preferably, the first semifinished product is a value document substrate, into and/or onto which the feature substance is introduced and/or applied, in particular by means of a printing process, in order to obtain the value document.

Alternatively or additionally, the first semifinished product can be a printing ink, into which the feature substance is introduced in order to obtain the second semifinished product in the form of a printing ink which contains the feature substance and by means of which a value document substrate can be printed.

Alternatively or additionally, the first semifinished product is a paper pulp, into which the feature substance is introduced and from which the second semifinished product, in particular in the form of a value document substrate, is manufactured.

Alternatively or additionally, the first semifinished product is a polymer melt, into which the feature substance is introduced and from which the second semifinished product, in particular in the form of a polymer substrate and/or a film strip, for introduction into and/or application onto a value document substrate, is then manufactured.

During the production of value documents, the at least one feature substance in the form of pulverulent substances or pigments can be added to the first semifinished product, e.g. a paper pulp, a masterbatch/polymer melt or a printing ink or a clearcoat or an ink concentrate. As a result, the first semifinished product is processed further to form the feature-containing second semifinished product, e.g. a pulp, a value document substrate (in web or sheet form), a printed product (in the form of a web, sheet or individual copy), a film element (patch, thread, film strip, planchettes), a fiber or a printing ink or an ink concentrate, or to form the finished value document.

It goes without saying that the preferred aspects and/or advantages mentioned above in connection with the production of a second semifinished product or a value document also apply, mutatis mutandis, to the sensor system which can be used for quality control during such a production method.

Preferably, the at least one capture apparatus comprises: an irradiation device configured to generate a third optical radiation and to cause the third optical radiation to impinge on the first semifinished product in the first operating mode and on the value document or the second semi-finished product in the second operating mode; and at least one detector device configured to capture the first optical radiation emanating from the first semifinished product and respectively the second optical radiation emanating from the value document or the second semifinished product in response to their being impinged on by the third optical radiation. In this embodiment, therefore, the irradiation device or the illumination used as excitation for the measurement of the signal intensity at the first semifinished product is the same as that used for the measurement of the feature intensity at the second semifinished product or the value document. This allows the use of a technically simpler and more expediently producible sensor or sensor system.

Alternatively, however, provision can preferably also be made for the at least one capture apparatus to comprise: a first irradiation device configured to generate a third optical radiation and to cause the third optical radiation to impinge on the first semifinished product in the first operating mode; a second irradiation device configured to generate a fourth optical radiation, which is different than the third optical radiation, and to cause the fourth optical radiation to impinge on the value document or the second semifinished product in the second operating mode; and at least one detector device configured to capture the first optical radiation emanating from the first semifinished product in response to its being impinged on by the third optical radiation and the second optical radiation emanating from the value document or the second semifinished product in response to its being impinged on by the fourth optical radiation. In this embodiment, therefore, the irradiation device or the illumination used as excitation for the measurement of the signal intensity at the first semifinished product is different than that used for the measurement of the feature intensity at the second semifinished product or the value document.

Preferably, the third optical radiation has a higher intensity and/or a broader spectrum and/or a greater number of different spectral components than the fourth optical radiation. In other words, during the measurement at the first semifinished product, the intensity of the illumination is preferably higher than during the measurement at the second semifinished product or the value document, such that a greater sensitivity is attained during the measurement at the first semifinished product. Alternatively or additionally, the illumination during the measurement at the first semifinished product can be over a spectrally wider band (e.g. two wavelengths instead of only one wavelength or spectrally wideband instead of a few discrete lines). This allows overall a more general, more non-specific or more sensitive detection of the signal intensity at the first semifinished product.

The sensor system can be formed by one and the same sensor, i.e. the same device, wherein this sensor comprises the at least one capture apparatus designed for capturing the first and the second optical radiation and comprises the at least one test apparatus for testing the first and second optical radiation. In this case, this sensor is optionally operable in the first operating mode or in the second operating mode.

Alternatively, the sensor system comprises a first sensor (“clean sensor”), which is specifically designed for capturing or testing the signal intensity at the first semifinished product and is operable in the first operating mode, and a second sensor (“feature sensor”), which is specifically designed for capturing or testing the feature intensity at the second semifinished product or the value document and is operable in the second operating mode. The first and/or second sensor can optionally be operable in the first or second operating mode. However, the first sensor can also be operable only in the first operating mode, but not in the second operating mode, and/or the second sensor can be operable only in the second operating mode, but not in the first operating mode. Preferably, the second sensor (with respect to its hardware or measuring elements) is structurally identical to the first sensor. The production outlay for the sensor system is reduced as a result.

In an alternative embodiment, however, the sensor system, for capturing or testing the signal intensity at the first semifinished product, can also comprise a first sensor (“clean sensor”) designed specifically therefor, which sensor is operable (only) in the first operating mode. Preferably, the first sensor is not equipped with the authentication algorithmic facility in connection with capturing or testing the feature intensity and/or does not contain certain separating elements—necessary for the selective feature identification—such as, for instance, filters and/or spectrometers or contains them only with relatively low quality. Preferably, the sensor system furthermore includes a second sensor (“feature sensor”) specifically designed for capturing or testing the feature intensity at the second semifinished product or the value document, which sensor is operable only in the second operating mode or optionally in the first and second operating modes. The second sensor is equipped with the required authentication algorithmic facility (for testing the second optical radiation on the basis of at least one second test criterion) and/or contains the separating elements necessary for a selective feature identification such as, for instance, filters and/or spectrometers.

If the first sensor that is used for quality control and captures the first optical radiation of the first semifinished product is operable only in the first operating mode, this first sensor advantageously need not be equipped with the possibly strictly confidential reference values nor with the authentication algorithmic facility nor with the separating elements which are necessary for selective feature identification and which the second sensor uses in the second operating mode during the final inspection of the second semifinished product or the value document.

Preferably, the sensor system, in particular the sensor or the first sensor, is configured such that it is (automatically) in the first operating mode directly after activation, in particular after switching on or start-up, and/or that it can be switched from the first operating mode to the second operating mode by an operator. In other words, the relevant sensor is in the clean mode after being switched on or started up and is manually switched to the measurement mode. This affords the advantage of a manner of operation adapted temporally to the production sequence, with fewer required settings or interventions. Furthermore, carrying out the first measurement at the first semifinished product cannot be forgotten here, since this is automatically integrated into the sequence.

The first test criterion or the first test signal relates e.g. to whether the intensity of the first optical radiation is less than a predefined first threshold value or whether a difference between two measured intensities of the first optical radiation, for example two intensities at different detection wavelengths, lies below a predefined first threshold value. The sensor system is designed to the effect that in the first operating mode, the first semifinished product is tested in respect of contaminants, in particular in regard to whether the influence of the contaminants on the first optical radiation is acceptably small.

The sensor system is preferably also designed to the effect that in the second operating mode on the basis of the at least one second test criterion, a test is conducted to check whether the ascertained characteristic property of the feature substance corresponds to a predefined property or is at least similar thereto, and/or whether or not the introduced and/or applied feature substance is the desired feature substance. The sensor system can also be designed to the effect that on the basis of the at least one second test criterion, a test is also conducted to check whether an intensity of the second optical radiation is greater than the predefined second threshold value and/or lies within a predefined tolerance interval, and/or whether a/the desired feature substance is present in the desired amount in/on the second semifinished product or the value document.

Further advantages, features and application possibilities of the present invention will become apparent from the following description in association with the figures, in which:

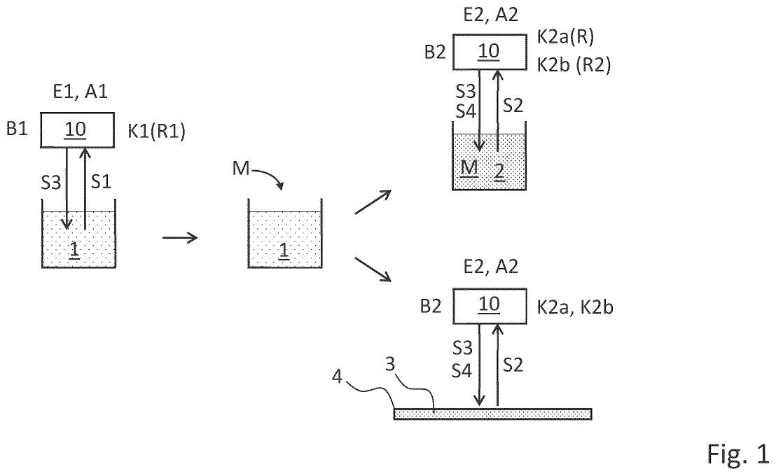

FIG. 1 shows a schematic illustration for elucidating one example of a method for producing value documents;

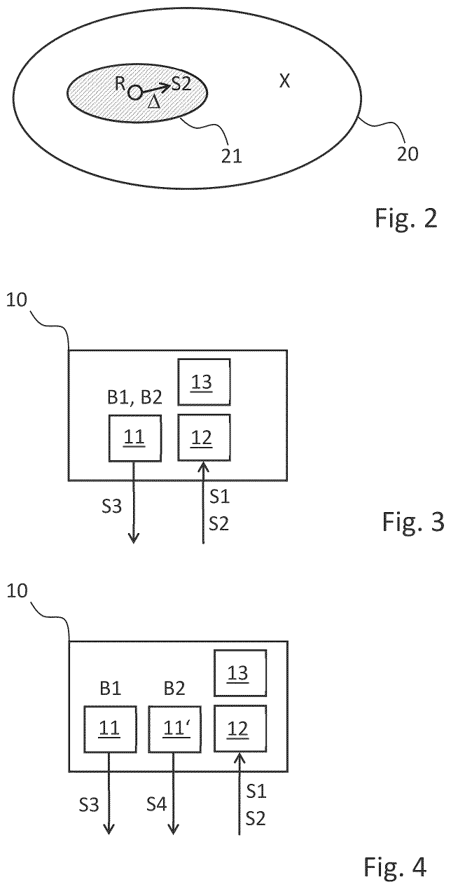

FIG. 2 shows a schematic illustration for elucidating one example of a test of the captured optical radiation;

FIG. 3 shows a first example of a sensor system;

FIG. 4 shows a second example of a sensor system; and

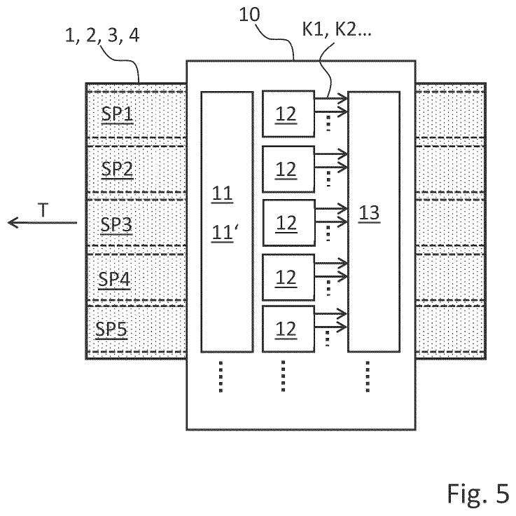

FIG. 5 shows a schematic illustration for elucidating further examples of a sensor system.

FIG. 1 shows a schematic illustration for elucidating one example of a method for producing value documents. By means of a sensor system 10, optical radiation S3 is caused to impinge on a provided first semifinished product 1, for example a printing ink, a paper pulp or a value document substrate, and the first optical radiation S1 (“signal intensity”) emanating from the first semifinished product 1 is captured.

The first optical radiation S1 is preferably radiation which is emitted or scattered by the first semifinished product 1 on account of luminescence or Raman scattering, in particular surface-enhanced Raman scattering, excited by the optical radiation S3 in the first semifinished product 1, and/or is reflected and/or transmitted by the first semifinished product 1 on account of at least partial absorption or (possibly inelastic) scattering of the optical radiation S3.

In a first operating mode B1, also referred to as “clean mode”, the sensor system 10 is configured to test the captured first optical radiation S1 on the basis of a first test criterion K1, for example by a test being conducted to check whether the intensity of the first optical radiation S1 is less than a predefined first threshold value R1.

If the test criterion K1 is satisfied, the first semifinished product 1 is released for further processing. If not, the first semifinished product 1 is removed or sorted out from the production process.

In the former case, at least one feature substance MS is added to the first semifinished product 1 in a further step. The at least one feature substance MS is preferably one or more substances which may be present for example in solid form, for instance as powder, mottled fibers and/or planchettes, or liquid form and have characteristic properties with regard to luminescence, Raman scattering and/or absorption which enable them to be reliably and/or unambiguously identified or distinguished from other substances and they can thus serve as an authenticity feature for value documents.

Depending on the first semifinished product 1 and/or the feature substance MS, by means of adding, introducing and/or applying the feature substance MS, a second semifinished product 2 for further use in the production of a value document 4 or a value document 4 is obtained.

If the first semifinished product 1 is a printing ink, for example, then by means of adding the feature substance MS a second semifinished product 2 is obtained in the form of a feature-containing printing ink, by means of which a value document substrate 3 can be printed during a printing process (not illustrated).

If the first semifinished product 1 is a paper pulp, for example, then by means of adding the feature substance MS a second semifinished product 2 is obtained in the form of a feature-containing paper pulp, from which a feature-containing value document substrate 3 can then be produced.

If the first semifinished product 1 is a—generally non-feature-containing—value document substrate, for example, then by means of introducing and/or applying, in particular printing, a feature substance MS present in the form of a feature-containing printing ink, for example, into and/or onto the value document substrate, an already finished value document 4 is obtained or a second semifinished product 2 is obtained in the form of a printed value document substrate 3, which can be processed further to form a value document 4 for example by applying and/or introducing further security features and/or by cutting to size.

It goes without saying that a plurality of first semifinished products 1 can also be tested by the method described, for example a (feature-free) paper pulp and a (feature-free) printing ink, before they are provided with one or more feature substances MS and are processed further as second semifinished products 2 or are processed to form a value document 4.

By means of the sensor system 10, optical radiation S3 or S4 is caused to impinge on the second semifinished product 2 or the value document 4 and the second optical radiation S2 (“feature intensity”) emanating from the second semifinished product 2 or the value document 4 is captured.

In a second operating mode B2, also referred to as “measurement mode”, the sensor system 10 is configured to test the captured second optical radiation S2 on the basis of at least one second test criterion K2a, K2b.

Preferably, in this case, in a first test step on the basis of a second test criterion K2a, a test is conducted to check whether the second optical radiation S2 exhibits at least one characteristic property or is characteristic of at least one characteristic property of the feature substance MS contained in the second semifinished product 2 or the value document 4, in particular by a test being conducted to check whether the characteristic property corresponds or is at least similar to a predefined property R (reference).

Preferably, in a second test step on the basis of a further second test criterion K2b, a test is conducted to check whether the intensity of the second optical radiation S2 is greater than a predefined second threshold value R2 and/or lies within a predefined tolerance interval.

If the second test criteria K2a and K2b are satisfied, then the second semifinished product 2 is released for further processing to form a value document or the value document 4 is released for circulation.

Preferably, the second test step is carried out only if the second test criterion K2a is satisfied in the first test step. If the latter is not the case, the second semifinished product 2 is not released for further processing or the value document 4 is not released for circulation. The second test step can be omitted in this embodiment.

In accordance with a particularly preferred aspect of the present disclosure, the first measurement on the non-feature-containing first semifinished product 1 is effected with a higher sensitivity E1 and/or a lower resolution A1 or specificity than the second measurement carried out on the feature-containing second semifinished product 2 or value document 4 with a lower sensitivity E2 and/or a higher resolution A2 or specificity. In this case, a higher sensitivity means in particular that a lower intensity already leads to a detector signal that is distinguishable from noise. In this case, a lower resolution or specificity means in particular that the first measurement on the first semifinished product 1, with regard to the temporal and/or spatial and/or spectral properties of the first optical radiation S1 emanating from the first semifinished product 1, is less resolved or selective than the second measurement on the second semifinished product 2 or value document 4.

As a result, during the second measurement of the feature intensity S2 at the value document 4 or the second semifinished product 2, the characteristic property of the feature substance MS contained therein can be accurately tested, while the preceding first measurement of the signal intensity S1 at the first semifinished product 1 is fast and simple and in particular also more sensitive with regard to small contaminants contained therein. As a result, contaminants in the first semifinished product 1 which may disturb the feature measurement on the second semifinished product 2 or the value document 4 can be identified at an early stage and, if appropriate, avoided by segregation of the relevant first semifinished product 1.

FIG. 2 shows a schematic illustration for elucidating one example of a test of the captured optical radiation.

In the second operating mode B2, the sensor 10 (see FIG. 1), in a first test step, firstly checks the correspondence between the measured signals S2 and the expected or predefined reference signals R to the effect of whether the signals S2 lie within a permitted delta (Δ) environment around the reference R. FIG. 2 here shows a greatly simplified schematic illustration of the generally multidimensional similarity comparison. Preferably, in this case, the term feature intensity or signal intensity S2 (and thus also the distance Δ) is also defined only within a predefined or accepted region 21 of a parameter space 20 and is to some extent meaningless in the case of correspondingly large deviations. Preferably, therefore, the measurement signals S2 must also lie within the delta environment with respect to the reference point R in order to be able to determine a feature intensity at all.

It preferably also transpires from this that general contaminants X in the second semifinished product 2 or the value document 4 cannot simply be quantified by the “feature sensor” (i.e. the sensor 10 in the second operating mode B2) in units of the feature intensity, for example, rather that a different metric is required for this.

In order to measure the signal intensity in the first operating mode of the sensor 10, therefore, generally optical signals S1 are recorded and quantified which, even in the absence of the feature substance MS, are a measure of disturbances which later, in the presence of the feature substance MS, could however detune the properties thereof.

Thus the parameter space 20 outside the delta environment can also be quantified, such that the manufacturer of the first semifinished product 1 obtains quantitative feedback concerning the quality of the first semifinished product 1 and from that can derive necessary steps, for example for cleaning the first semifinished product 1 itself and/or the equipment coming into contact with the first semifinished product 1. Conversely, the signal intensities S1 in the first operating mode B1 of the sensor 10 are generally not suitable for deriving a feature intensity therefrom, since other measurement conditions with regard to spectral or temporal specificity are used here in a targeted manner.

FIG. 3 shows a first example of a sensor system 10, which is preferably configured such that it can be used both for capturing or testing the first optical radiation S1 emanating from the first semifinished product (not illustrated, see FIG. 1) and for capturing or testing the second optical radiation S2 emanating from the second semifinished product or the value document (not illustrated, see FIG. 1).

In this case, the sensor system 10 is configured to be operated in a first operating mode B1 (clean mode), in which a first measurement or test of the first optical radiation S1 or signal intensity is effected with low specificity and/or high sensitivity, wherein the signal intensity is preferably compared with a first threshold value R1. For this purpose, the sensor system 10 comprises an irradiation device 11 for generating a third optical radiation S3, which impinges on the first semifinished product, a detector device 12 for capturing the first optical radiation S1 emanating from the first semifinished product, and a test apparatus 13 for testing the first optical radiation S1.

Furthermore, the sensor system 10 is configured to be operated in a second operating mode (measurement mode), in which a second measurement or test of the second optical radiation S2 or feature intensity is effected with high specificity and/or lower sensitivity, wherein a characteristic property of the feature substance is determined and tested on the basis of a reference R and, in the case of success, the feature intensity is determined and tested on the basis of a second threshold value R2.

In the present embodiment of the sensor system 10, in the second operating mode B2 the irradiation device 11 generates the same—with regard to the spectrum, temporal sequence and/or intensity—third optical radiation S3 as in the first operating mode B1, such that the optical radiation S3 which impinges on the second semifinished product or the value document is the same as that which impinges on the first semifinished product in the first operating mode B1. The second optical radiation S2 thereupon emanating from the second semifinished product or the value document is captured by means of the detector device 12 and tested in the test device 13 as described above.

FIG. 4 shows a second example of a sensor system 10, which differs from the example shown in FIG. 3 in that a second irradiation device 11′ is provided in addition to a first irradiation device 11, wherein in the first operating mode B1 of the sensor system 10 the first irradiation device 11 generates a third optical radiation S3, which impinges on the first semifinished product, and in the second operating mode B2 the second irradiation device 11′ generates a fourth optical radiation S4, which differs from the third optical radiation S3 and impinges on the second semifinished product or the value document. In contrast to the example shown in FIG. 3, in this embodiment, therefore, the optical radiation which impinges on the first semifinished product is different than that which impinges on the feature-containing second semifinished product or value document. For the rest, the above explanations in connection with the example shown in FIG. 3 apply, mutatis mutandis, to the example shown in FIG. 4.

Further preferred or alternative embodiments or aspects of the method for producing value documents and of the sensor system 10 for quality control during the production of value documents are described in greater detail below.

In connection with the present disclosure, the term “specificity” is preferably used both for the spectral and/or spatial and/or temporal resolution during the capture of the relevant optical radiation S1 or S2 and for the so-called “selectivity”, i.e. for selection of components or data from the corresponding measurement signals that is performed in connection with the testing of the respective optical radiation S1 or S2.

Preferably, the spectral and temporal measurement range of the clean mode B1 comprises the spectral and temporal measurement range of the measurement mode B2.

Preferably, the measurement mode B2 has a higher specificity than the clean mode B1 with regard to the spatial and/or temporal and/or spectral distribution of the signals.

Preferably, the clean mode B1 has a higher sensitivity than the measurement mode B2, i.e. in the clean mode B1 smaller signals or signal intensities can be detected or distinguished from noise, which can be achieved e.g. by setting longer integration or averaging times at the detector device 12.

Preferably, the sensor system 10 is configured such that it automatically starts in the first operating mode B1 and can be manually switched to the second operating mode B2.

Preferably, the optical radiation S3 and/or S4 and/or respectively S1 and/or S2 which is radiated in and/or emanates, in particular is emitted, from the first semifinished product 1 and/or respectively the second semifinished product 2 or the value document 4 during the measurement in the first operating mode B1 and/or in the second operating mode B2 is invisible to the human eye, i.e. the optical radiation S3 and/or S4 and/or respectively S1 and/or S2 substantially lies outside the visible spectral range (approximately 380 nm to approximately 780 nm).

Furthermore, it is preferred for the measurement of the signal intensity S1 and feature intensity S2 to take place on different scales, i.e. the same light emission of the first semifinished product 1, during measurement in the first operating mode B1, corresponds to a first signal intensity and, during measurement in the second operating mode B2, corresponds to a second feature intensity, which is numerically different, in particular different not just by a constant factor. In particular, feature intensity S2 and signal intensity S1 cannot be converted into one another (e.g. owing to spectrally different distributions of the light power).

Preferably, the sensor system 10 is configured to measure semifinished products 1 and respectively 2 present in at least two different forms, which in particular can be at least two of the following forms: sheet material (individual copy or whole sheet, printed or unprinted), substrate web, paper pulp, polymer melt, printing ink, clearcoat, ink concentrate, pigment, powder, film element.

Preferably, the sensor system 10 or the test device 13 can be configured to convert a signal intensity or feature intensity that was measured at a semifinished product 1 or respectively 2 in a first form into a respectively corresponding signal intensity or feature intensity that is to be expected upon measurement at the semifinished product 1 or 2 after further processing into a second form.

Preferably, a semifinished product 2 with a feature intensity above the second threshold value R2 always yields signal intensities which are greater than the first threshold value R1.

Preferably, the signal intensity in the first operating mode B1 corresponds to the maximum of the feature intensity over a specific measurement duration and/or a specific spatial measurement range.

Preferably, the sensor system 10 is configured to automatically switch from the second operating mode B2 to the first operating mode B1 if, in the second operating mode B2, the characteristic property of the security feature is sufficiently far away from the reference value R or the characteristic property could not be determined.

Alternatively or additionally, the sensor system 10 can be configured to start in the first operating mode B1 and to automatically change to the second operating mode B2 only if the captured signal intensity is small enough.

Preferably, the sensor system 10 can furthermore be configured to determine an offset value in the clean mode B1 and to transfer said offset value to the measurement mode B2 or to use it therein in order to correct the feature signal or the feature intensity with regard to the influences caused by contaminants.

FIG. 5 shows a schematic illustration for elucidating further examples of a sensor system 10. The illustration shows a schematic plan view of the sensor system 10, beneath which is situated a measurement object 1 to 4 to be tested, which can be a first semifinished product 1, a second semifinished product 2 or a value document substrate 3 or a value document 4 depending on the use or operating mode of the sensor system 10. In the present example, a measurement object in sheet form is illustrated for reasons of clarity.

The sensor system 10 is configured to capture optical radiation emanating from the measurement object 1 to 4 while both are moved relative to one another in a transport direction T. By way of example, in this case, the sensor system 10 can be stationary and the measurement object 1 to 4 can be conveyed past the sensor system 10 in the transport direction T by means of a suitable transport device (not illustrated), for example rollers, belts and/or rolls. Conversely, provision can be made for the measurement object 1 to 4 to be stationary and for the sensor system 10 to be moved relative to the measurement object 1 to 4.

In this case, the sensor system 10 is configured in particular to capture the optical radiation emanating from the measurement object 1 to 4 during the relative movement along one or more tracks SP1 to SP5. For this purpose, the sensor system 10 comprises a number of detector devices 12 corresponding to the number of tracks, wherein each of the detector devices 12 is assigned to one of the tracks SP1 to SP5.

Preferably, the detector devices 12 are each configured to capture the optical radiation emanating from the measurement object 1 to 4 in one or more spectral ranges or spectral channels K1, K2, . . . and to forward the corresponding signals into a test apparatus 13, in which they are processed further or tested.

In the present example, a first and optionally additional second irradiation device 11 and respectively 11′ is configured to cause optical radiation to impinge simultaneously on all the tracks SP1 to SP5 on the measurement object 1 to 4. As an alternative thereto, however, provision can also be made for providing a dedicated irradiation device 11 and optionally 11′ for each of the tracks SP1 to SP5.

The above explanations in association with FIGS. 1 to 4 apply, mutatis mutandis, to the excitation, capture and testing of the optical radiation emanating from the measurement object 1 to 4.

The sensor system 10 can be configured differently with regard to the properties to be measured (e.g. luminescence, Raman scattering, in particular SERS, absorption), number of tracks SP1 to SP5 and/or number of spectral channels K1, K2, . . . , a description being given below, by way of example, of some preferred embodiments which also show various possibilities for realizing a lower or higher specificity when capturing or testing the optical radiation in the first and second operating modes.

In this respect, the sensor system 10 can be configured as a luminescence single-track sensor with just one spectral channel. In this case, provision can be made in particular to the effect that in the first operating mode (clean mode), no decay time test takes place (test is non-specific in relation to decay time), and/or in the second operating mode (measurement mode), only signals with an appropriate decay time are taken into account (test is specific or selective in relation to decay time).

The sensor system 10 can also be configured as a luminescence single-track sensor with 10 spectral channels. Preferably, in this case, spectrally wideband measurement or testing takes place in the clean mode, wherein the sum of the intensities over all the spectral channels is formed and/or a (intensity) maximum is ascertained from all the spectral channels (test is non-specific in relation to the spectral channels). In the measurement mode, by contrast, only signals which were spectrally identified are measured or tested (test is specific or selective in relation to the spectral channels).

Furthermore, the sensor system 10 can be configured as a luminescence 5-track sensor with 5 spectral channels, wherein in the clean mode spectrally wideband (sum of the signals of a plurality of spectral channels and/or maximum from all the tracks) measurement or testing takes place (test is non-specific in relation to the spectral channels and/or tracks), whereas in the measurement mode only signals which were spectrally identified and occur in predefined or determined tracks are taken into account (test is specific or selective in relation to the spectral channels and tracks).

The sensor system 10 can also be configured as a luminescence 6-track sensor with 5 spectral channels, wherein in the clean mode spectrally wideband (maximum of all the spectral channels and/or maximum from all the tracks without temporal testing) measurement or testing takes place (test is non-specific in relation to the spectral channels, tracks and/or the temporal behavior). In the measurement mode only signals which were identified spectrally and on the basis of the temporal behavior are taken into account (test is specific or selective in relation to the spectral channels and the temporal behavior).

Furthermore, the sensor system 10 can be configured as a luminescence 10-track sensor with one spectral channel, wherein in the clean mode the maximum over all the tracks without temporal testing is used (test is non-specific in relation to the tracks and the temporal behavior), whereas in the measurement mode only signals which were identified on the basis of the temporal behavior and occur in the correct tracks are taken into account (test is specific or selective in relation to the tracks and the temporal behavior).

The sensor system 10 can also be configured as an SERS single-track sensor with 1000 spectral channels, wherein the sum over all the spectral channels is taken into account in the clean mode, whereas only signals in specific spectral ranges are taken into account in the measurement mode.

Furthermore, the sensor system 10 can be configured as an SERS single-track sensor with 100 spectral channels, wherein the sum over specific spectral channel ranges (e.g. channels 7-34 and 48-61, the maximum thereof) is taken into account in the clean mode, whereas only signals in specific narrower spectral ranges (e.g. channels 9-12 and 21-30) are taken into account in the measurement mode.

The sensor system 10 can also be configured as an SERS single-track sensor with 16 spectral channels, wherein the sum over all the spectral channels is taken into account in the clean mode, whereas only signals in specific spectral ranges (e.g. channels 5-7 and 9) are taken into account in the measurement mode.

Moreover, the sensor system 10 can be configured as an SERS 2-track sensor with 256 spectral channels, wherein the sum over specific spectral channel ranges (e.g. channels 17-134 and 150-200, the maximum thereof; maximum of the tracks) is taken into account in the clean mode, whereas only signals in specific narrower spectral ranges (e.g. channels 59-82 and 180-192) are taken into account in the measurement mode.

The sensor system 10 can also be configured as a single-track sensor for determining absorption properties by means of reflection measurement with 64 spectral channels, wherein spectrally wideband (maximum of all the spectral channels) measurement or testing takes place in the clean mode, whereas only signals which were spectrally identified are taken into account in the measurement mode.

Furthermore, the sensor system 10 can be configured as an 8-track sensor for determining absorption properties by means of reflection measurement with 30 spectral channels, wherein spectrally wideband (maximum from all the spectral channels and/or mean value from all the tracks) measurement or testing takes place in the clean mode, whereas only signals which were spectrally identified are taken into account in the measurement mode.

1.-15. (canceled)

16. A method for producing value documents, in particular banknotes, comprising the following steps:
providing at least one first semifinished product,
capturing a first optical radiation emanating from the first semifinished product with at least one first sensitivity and at least one first resolution of temporal, spatial and/or spectral properties of the first optical radiation, and
testing the first optical radiation on the basis of a first test criterion and, if the first test criterion is satisfied,
introducing and/or applying at least one feature substance into and/or onto the first semifinished product, wherein a value document or a second semifinished product usable for producing a value document is obtained in which the feature substance is invisible to the naked eye,
capturing a second optical radiation emanating from the value document or the second semifinished product with at least one second sensitivity and at least one second resolution of temporal, spatial and/or spectral properties of the second optical radiation, and
testing the second optical radiation on the basis of at least one second test criterion and, if the at least one second test criterion is satisfied, releasing the value document for circulation or releasing the second semifinished product for use in the production of a value document,
wherein
the first sensitivity is greater than the second sensitivity and/or
the first resolution is less than the second resolution, and/or
the testing of the first optical radiation with regard to the temporal, spatial and/or spectral properties of the first optical radiation is less selective than the testing of the second optical radiation with regard to the temporal, spatial and/or spectral properties of the second optical radiation.

17. The method as claimed in claim 16, wherein on the basis of the at least one first test criterion, a test is conducted to check whether an intensity of the first optical radiation is less than a predefined first threshold value or whether a difference between two measured intensities of the first optical radiation, for example two intensities at different detection wavelengths, lies below a predefined first threshold value.

18. The method as claimed in claim 16, wherein on the basis of the at least one first test criterion, in particular on the basis of the predefined first threshold value, the first semifinished product is tested in regard to contaminants, e.g. in regard to whether the influence of the contaminants on the first optical radiation is acceptably small.

19. The method as claimed in claim 16, wherein on the basis of the second optical radiation, at least one characteristic property of the feature substance introduced into and/or applied onto the value document, or the second semi-finished product is ascertained.

20. The method as claimed in claim 16, wherein in a first test step on the basis of the at least one second test criterion, a test is conducted to check whether the ascertained characteristic property of the feature substance corresponds to a predefined property or is at least similar thereto, in particular whether the introduced and/or applied feature substance is the desired feature substance.

21. The method as claimed in claim 16, wherein in a second test step on the basis of the at least one second test criterion, a test is conducted to check whether an intensity of the second optical radiation is greater than a predefined second threshold value and/or lies within a predefined tolerance interval,
wherein on the basis of the predefined second threshold value and/or the predefined tolerance interval, in particular a test is conducted to check whether the feature substance is present in the desired amount in/on the second semi-finished product or the value document.

22. The method as claimed in claim 20, wherein the second test step is carried out after the first test step and/or is carried out only if the at least one second test criterion is satisfied in the first test step.

23. The method as claimed in claim 16, wherein the captured first and/or second optical radiation are/is characteristic of at least one of the following optical properties of the first semifinished product and/or the value document or the second semifinished product: luminescence, Raman scattering, in particular surface-enhanced Raman scattering (SERS), and/or absorption.

24. The method as claimed in claim 16, wherein the captured first and second optical radiation are characteristic of the same optical property, in particular both characteristic of luminescence, Raman scattering, surface-enhanced Raman scattering (SERS) or absorption, of the first semifinished product and the value document or the second semifinished product, and/or
wherein capturing the first optical radiation at the first semifinished product and capturing the second optical radiation at the second semifinished product or the value document are effected by the same optical measurement method, in particular by measurement of the luminescence or by measurement of the Raman scattering, in particular surface-enhanced Raman scattering (SERS), or by measurement of the absorption.

25. The method as claimed in claim 16, wherein the first semifinished product
is a value document substrate, into and/or onto which the feature substance is introduced and/or applied, in particular by means of a printing process, in order to obtain the value document, and/or
is a printing ink, into which the feature substance is introduced in order to obtain the second semifinished product in the form of a printing ink which contains the feature substance and by means of which a value document substrate can be printed, and/or
is a paper pulp, into which the feature substance is introduced in order to obtain the second semifinished product, in particular in the form of a value document substrate, and/or
is a polymer melt, into which the feature substance is introduced in order to obtain the second semifinished product, in particular in the form of a polymer substrate and/or a film strip, for introduction into and/or application onto a value document substrate.

26. The method as claimed in claim 16, wherein a sensor used for capturing and testing the second optical radiation is structurally identical to or the same as that used for capturing and testing the first optical radiation.

27. A sensor system for quality control during the production of value documents which involves at least one feature substance being introduced into and/or applied onto a first semifinished product in order to obtain a value document or a second semifinished product usable for producing a value document,
wherein the sensor system comprises at least one capture apparatus for capturing optical radiation and at least one test apparatus for testing the captured optical radiation and is operable in a first operating mode and in a second operating mode, wherein
in the first operating mode the at least one capture apparatus captures a first optical radiation emanating from the first semifinished product with at least one first sensitivity and at least one first resolution of temporal, spatial and/or spectral properties of the first optical radiation, and the at least one test apparatus tests the first optical radiation on the basis of a first test criterion and generates and/or outputs a first test signal, which is dependent on whether the first test criterion is satisfied, and
in the second operating mode the at least one capture apparatus captures a second optical radiation emanating from the value document or from the second semifinished product with at least one second sensitivity and at least one second resolution of temporal, spatial and/or spectral properties of the second optical radiation, and the at least one test apparatus tests the second optical radiation on the basis of at least one second test criterion and generates and/or outputs a second test signal, which is dependent on whether the at least one second test criterion is satisfied, and wherein
the first sensitivity is greater than the second sensitivity and/or
the first resolution is less than the second resolution and/or
the testing of the first optical radiation with regard to the temporal, spatial and/or spectral properties of the first optical radiation is less selective than the testing of the second optical radiation with regard to the temporal, spatial and/or spectral properties of the second optical radiation.

28. The sensor system as claimed in claim 27, wherein the sensor system is configured such that it is in the first operating mode directly after activation, in particular after switching on or start-up, and/or that it can be switched from the first operating mode to the second operating mode by an operator.

29. The sensor system as claimed in claim 27, wherein the at least one capture apparatus comprises:
an irradiation device configured to generate a third optical radiation and to cause the third optical radiation to impinge on the first semifinished product in the first operating mode and on the value document or the second semifinished product in the second operating mode, and
at least one detector device configured to capture the first optical radiation emanating from the first semifinished product and respectively the second optical radiation emanating from the value document or the second semifinished product in response to their being impinged on by the third optical radiation.

30. The sensor system as claimed in claim 27, wherein the at least one capture apparatus comprises:
a first irradiation device configured to generate a third optical radiation and to cause the third optical radiation to impinge on the first semifinished product in the first operating mode,
a second irradiation device configured to generate a fourth optical radiation, which is different than the third optical radiation, and to cause the fourth optical radiation to impinge on the value document or the second semifinished product in the second operating mode, and
at least one detector device configured to capture the first optical radiation emanating from the first semifinished product in response to its being impinged on by the third optical radiation and respectively the second optical radiation emanating from the value document or the second semifinished product in response to its being impinged on by the fourth optical radiation,
wherein the third optical radiation has in particular a higher intensity and/or a broader spectrum and/or a greater number of different spectral components than the fourth optical radiation.
